(19) United States
(12) Patent Application Publication
(10) Pub. No.: US 2026/0318314 A1
(43) Pub. Date: Oct. 15, 2026

(54) BLOWER

(71) Applicant: MINEBEA MITSUMI Inc., Kitasaku-gun, Nagano (JP)

(72) Inventor: Jinko IKEDA, Kitasaku-gun, Nagano (JP)

(21) Appl. No.: 19/105,517

(22) PCT Filed: Jan. 24, 2024
(86) PCT No.: PCT/JP2024/001958

§ 371 Date: Feb. 21, 2025

(30) Foreign Application Priority Data
Feb. 10, 2023 (JP) 2023-019097
Dec. 18, 2023 (JP) 2023-212865

(51) Int. Cl. F04D 29/056; F04D 19/00; F04D 29/051

(52) U.S. Cl. CPC F04D 29/056; F04D 19/002; F04D 29/051

(57) ABSTRACT

A blower capable of increasing a rotation speed of an impeller is provided. A blower includes: a shaft; a sleeve; an impeller rotatably supported at one side in an axial direction of the shaft, the impeller generating, by rotating, an airflow from one side toward another side in the axial direction; a first ball bearing including an inner ring supported by a part close to the impeller at the shaft and an outer ring fixed at an inner peripheral surface of the sleeve; a second ball bearing with an inner ring supported at a part farther from the impeller than the inner ring at the shaft; a first flange part supported at a part between the inner ring and the inner ring at the shaft and sticking outward in a radial direction from the shaft; and a first spring disposed between the first flange part and the inner ring. The first flange part pushes the inner ring from the other side toward the one side when the impeller rotates.

### TECHNICAL FIELD

The present invention relates to a blower.

### BACKGROUND ART

There is a known device including a rotation shaft rotatably supported by two ball bearings and an impeller attached to the rotation shaft and rotating together with the rotation shaft (see, for example, Patent Document 1 below). In the device described in Patent Document 1, when the impeller rotates, an airflow is generated from the impeller side toward the opposite side of the impeller in the axial direction. Then, against the airflow, a thrust force (thrust) from the opposite side of the impeller toward the impeller side is generated with respect to the rotation shaft or the like.

In the device described in Patent Document 1, a preload spring is disposed at a side closer to the impeller than a ball bearing at a side closer to the impeller. In the device described in Patent Document 1, during rotation of the impeller, the ball bearing at the side close to the impeller receives a biasing force in a direction opposite to the acting direction of the thrust force (direction from the impeller side to the side opposite to the impeller) by the preload spring, and is applied with a preload.

### CITATION LIST

### Patent Document

Patent Document 1: Japanese Patent Application Laid-Open No. 2017-210878

### SUMMARY OF INVENTION

### Technical Problem

In general, the thrust force increases in accordance with the rotation speed of the impeller. In the device described in Patent Document 1, the preload spring applies a biasing force to the ball bearing at the side close to the impeller in the direction opposite to the direction of the thrust force acting. Therefore, in the device described in Patent Document 1,in order to constantly apply a preload to the ball bearing during rotation of the impeller, it is necessary to increase the biasing force of the preload spring as the rotation speed of the impeller increases. However, in general, a maximum value (prescribed value) is determined for the surface pressure applied to the ball bearing. That is, there is an upper limit to the preload applicable to the ball bearing. Therefore, it has been difficult to increase the rotation speed of the impeller due to such restriction of the known ball bearing.

Therefore, an object of the present invention is to provide a blower capable of increasing a rotation speed of an impeller.

### Solution to Problem

A blower according to the present invention includes: a shaft; a sleeve internally accommodating a part of the shaft; an impeller rotatably supported at one side in an axial direction of the shaft, the impeller generating, by rotating, an airflow from one side in the axial direction toward another side in the axial direction; a first ball bearing including an inner ring supported by a part close to the impeller at the shaft and an outer ring fixed at an inner peripheral surface of the sleeve; a second ball bearing with an inner ring supported at a part farther from the impeller than the inner ring of the first ball bearing at the shaft; a first flange part supported at a part between the inner ring of the first ball bearing and the inner ring of the second ball bearing at the shaft and sticking outward in a radial direction perpendicular to the axial direction from the shaft; and a first spring disposed between the first flange part and the inner ring of the second ball bearing. In this blower, the first flange part pushes the inner ring of the first ball bearing from the other side toward the one side when the impeller rotates.

Another blower of the present invention includes: a shaft; a sleeve internally accommodating a part of the shaft; an impeller rotatably supported at one side in an axial direction of the shaft, the impeller generating, by rotating, an airflow from one side in the axial direction toward another side in the axial direction; a first ball bearing including an inner ring supported by a part close to the impeller at the shaft and an outer ring disposed at an inner periphery of the sleeve; a second ball bearing with an inner ring supported at a part farther from the impeller than the inner ring of the first ball bearing at the shaft; a first flange part supported at a part between the inner ring of the first ball bearing and the inner ring of the second ball bearing at the shaft and sticking outward in a radial direction perpendicular to the axial direction from the shaft; and a first spring disposed between the first flange part and the inner ring of the second ball bearing, in which the inner periphery of the sleeve is provided with a sticking out part protruding inward in the radial direction, an end part at the one side of the first ball bearing is in contact with the sticking out part, and the first flange part pushes the inner ring of the first ball bearing from the other side toward the one side when the impeller rotates.

These blowers may further include at least one of the following configurations.

The impeller may form a part of a rotor rotating with respect to the sleeve along with rotation of the shaft, and a maximum value of a load by the first spring may be smaller than a load by the rotor.

The outer ring of the second ball bearing may be restricted in movement in the axial direction.

The blower may further include a fixed part fixed at an inner peripheral surface of the sleeve and sticking out inward in the radial direction, in which the sleeve may include a step part protruding inward in the radial direction at a part at the one side relative to the fixed part, and the outer ring of the second ball bearing may be sandwiched between the step part and the fixed part and restricted in movement in the axial direction.

The blower may further include: a second flange part supported by a part at the other side relative to the inner ring of the second ball bearing at the shaft and sticking outward in the radial direction from the shaft; and a second spring disposed between the second flange part and the inner ring of the second ball bearing. In this case, the impeller may form a part of a rotor rotating with respect to the sleeve along with rotation of the shaft, and a change amount of a load (biasing force) by the first spring and the second spring when a deflection amounts of the first spring and the second spring change by an axial gap of the first ball bearing and the second ball bearing is larger than a weight of the inner ring of the second ball bearing.

The blower may further include a second flange part supported by a part at the other side relative to the inner ring of the second ball bearing at the shaft and sticking outward in the radial direction from the shaft, in which the inner peripheral surface of the sleeve may include a step part protruding inward in the radial direction at a part between the outer ring of the first ball bearing and the outer ring of the second ball bearing in the axial direction, a third spring may be disposed between the step part and the outer ring of the second ball bearing in the axial direction, and the second flange part may push the inner ring of the second ball bearing from the other side toward the one side when the impeller rotates. In this case, the impeller may form a part of a rotor rotating with respect to the sleeve along with rotation of the shaft, and each of a maximum value of a load by the first spring and a maximum value of a load by the third spring may be smaller than a load by the rotor.

In the blower, a washer may be supported at a surface at the other side at the impeller, and the shaft may penetrate the washer.

### Advantageous Effects of Invention

According to the present invention, a blower capable of increasing a rotation speed of an impeller is provided.

### BRIEF DESCRIPTION OF DRAWINGS

FIG. 1 is an axial cross-sectional view illustrating a blower in a first embodiment of the present invention.

FIG. 2 is an enlarged cross-sectional view schematically illustrating the bearing device illustrated in FIG. 1 when the impeller is stationary.

FIG. 3 is an enlarged cross-sectional view schematically illustrating the bearing device illustrated in FIG. 1 when the impeller is rotating.

FIG. 4 is an axial cross-sectional view illustrating a blower in a second embodiment of the present invention.

FIG. 5 is an enlarged cross-sectional view schematically illustrating the bearing device illustrated in FIG. 4 when the impeller is stationary.

FIG. 6 is an enlarged cross-sectional view schematically illustrating the bearing device illustrated in FIG. 4 when the impeller is rotating.

FIG. 7 is an axial cross-sectional view illustrating a blower in a third embodiment of the present invention.

FIG. 8 is an enlarged cross-sectional view schematically illustrating the bearing device illustrated in FIG. 7 when the impeller is stationary.

FIG. 9 is an enlarged cross-sectional view schematically illustrating the bearing device illustrated in FIG. 7 when the impeller is rotating.

FIG. 10 is an axial cross-sectional view illustrating a blower in a fourth embodiment of the present invention.

FIG. 11 is an enlarged cross-sectional view schematically illustrating the bearing device illustrated in FIG. 10 when the impeller is stationary.

### DESCRIPTION OF EMBODIMENTS

Embodiments for carrying out a blower according to the present invention will be described below together with the accompanying drawings. The embodiments described below are intended to facilitate the understanding of the present invention and are not intended to be construed as limiting the present invention. The present invention can be modified and improved from the following embodiments without departing from the gist of the present invention. In the accompanying drawings, dimensions of each member may be exaggerated or reduced, or hatching may be omitted for facilitating the understanding.

### First Embodiment

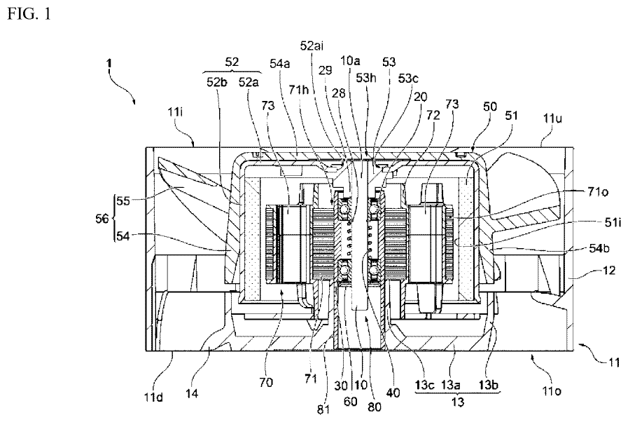

FIG. 1 is an axial cross-sectional view illustrating a blower in the present embodiment. As illustrated in FIG. 1, a blower 1 includes a casing 11, a bearing device 80, a stator 70, and a rotor 50 as main components.

The bearing device 80 includes a tubular (cylindrical in the present embodiment) sleeve 81, a shaft 10, a first ball bearing 20, a second ball bearing 30, a washer 29, a first flange part 28, a first spring 40, and a fixed part 60.

The sleeve 81 is made of metal, for example, and accommodates the first ball bearing 20, the second ball bearing 30, the first flange part 28, the first spring 40, the fixed part 60, a part of the shaft 10, and the like.

The shaft 10 passes through the center of the sleeve 81 in the radial direction. A part of the shaft 10 is a protrusion part 10a a protruding outward from the inside of the sleeve 81. In the present embodiment, the blower 1 is configured concentrically such that the shaft 10 is positioned at the center in the radial direction. However, the positional relationship of the shaft 10 and the like in the blower 1 is not limited to a concentric shape. The longitudinal direction of the shaft 10 is an axial direction of the blower 1, and the axial direction is perpendicular to the radial direction. Note that hereinafter, in the axial direction, a side toward the protrusion part 10a side may be called “up”, “upper”, “upper side”, or “one side”, and a side toward the side opposite to the protrusion part 10a may be called “down”, “lower”, “lower side”, or “other side”. In the radial direction, a side close to the shaft 10 may be called “inner” or “inside”, and a side far from the shaft 10 may be called “outer” or “outside”.

The first ball bearing 20 is attached to the shaft 10 in the vicinity of the protrusion part 10a (i.e., one side of the shaft 10). In the axial direction, the protrusion part 10a is present upper than the first ball bearing 20. The second ball bearing 30 is attached to the vicinity of the lower end part of the shaft 10 (i.e., the other side of the shaft 10). The second ball bearing 30 is present lower than the first ball bearing 20. The first ball bearing 20 and the second ball bearing 30 rotatably support the shaft 10.

The washer 29 is present upper than the first ball bearing 20, and the shaft 10 penetrates a hole formed at the center in the radial direction of this washer 29. The first flange part 28 is present lower than the first ball bearing 20 and is supported by the shaft 10. The first spring 40 is disposed between the first flange part 28 and the second ball bearing 30 in the axial direction. The fixed part 60 is disposed lower than the second ball bearing 30.

Note that the bearing device 80 will be described in more detail later.

The casing 11 has a tubular shape, and may be, for example, substantially square, substantially rectangular, circular, or the like when viewed from the axial direction. The internal space of the casing 11 is an air channel. In the air channel, an airflow flows along the axial direction from the upper side toward the lower side. That is, an inlet 11i for sucking air into the internal space of the casing 11 is formed at the upper end part 11u of the casing 11, and an outlet 110 for flowing out air is formed at the lower end part 11d of the casing 11. The internal space of the casing 11 accommodates the bearing device 80, the stator 70, the rotor 50, and the like. The casing 11 includes a side wall 12, a base part 13, and a fixed vane 14.

The side wall 12 is present more radially outside than the rotor 50 and surrounds the periphery of the rotor 50. The side wall 12 is connected to the upper end part 11u of the casing 11. The side wall 12 has a tubular shape about the shaft 10, and is disposed with a gap from the rotor 50. The side wall 12 also has a function of protecting the rotor 50, the bearing device 80, and the like disposed inside.

The fixed vane 14 includes a plurality of stationary blades. The side wall 12 and the base part 13 are connected in the radial direction via this fixed vane 14.

The base part 13 includes a disk-shaped bottom part 13a perpendicular to the axial direction, a cylindrical outer peripheral wall 13b extending by a predetermined length upward along the axial direction from an outer end part of the bottom part 13a, and a cylindrical boss part 13c protruding by a predetermined length upward along the axial direction from an inner end part of the bottom part 13a. The outer peripheral wall 13b and the boss part 13c are concentric with the shaft 10.

The fixed vane 14 is integrally formed at an outer peripheral surface of the outer peripheral wall 13b. That is, the outer peripheral wall 13b is supported by the side wall 12 via the fixed vane 14. The sleeve 81 of the bearing device 80 is attached to an inner peripheral surface of the boss part 13c by press-fitting, for example.

The side wall 12, the base part 13, and the fixed vane 14 of the casing 11 may be integrally formed by injection molding of synthetic resin (e.g., polybutylene terephthalate resin). In place of the fixed vane 14 connecting the side wall 12 and the base part 13, a plurality of spokes including rod-like parts may be used.

Next, the stator 70 will be described.

The stator 70 includes a stator core 71, an insulator 72, and a plurality of coils 73 as main components.

In the present embodiment, the stator core 71 is formed of a laminated body having lamination of a plurality of cores of electromagnetic steel sheets made of a soft magnetic material. The stator core 71 is positioned outside the sleeve 81 of the bearing device 80. In the present embodiment, an opening part 71h having a circular shape is formed at an inner peripheral surface of the stator core 71. The sleeve 81 penetrates the opening part 71h of this stator core 71 in the axial direction. The sleeve 81 is attached to the stator core 71 by, for example, being press-fitted into the opening part 71h of the stator core 71. Note that the stator core 71 may be fixed at the sleeve 81 in combination with an adhesive.

The insulator 72 is made of an insulation material, and is mounted to the stator core 71 to cover a part of the stator core 71. An outer peripheral surface 710 of the stator core 71 is exposed from the insulator 72. Each of the plurality of coils 73 is wound around the stator core 71 via the insulator 72 at a predetermined interval in the circumferential direction of the stator core 71. Therefore, the stator core 71 and the plurality of coils 73 are insulated via the insulator 72.

Next, the rotor 50 will be described.

The rotor 50 includes an impeller 56, a rotor yoke 52, a magnet 51, and a bush 53 as main components.

The impeller 56 includes a hub 54 and a plurality of blades 55 provided along the circumferential direction at an outer peripheral surface of the hub 54. The hub 54 and the plurality of blades 55 may be integrally formed by injection molding synthetic resin (e.g., a polybutylene terephthalate resin containing glass fiber), for example.

The hub 54 has a cup-like shape with a bottomed substantially inverted U-shaped cross section, and includes a plate-shaped base 54a perpendicular to the axial direction, and a tubular (cylindrical) side wall 54b extending substantially along the axial direction from an outer end part of the base 54a. The hub 54 is disposed with the base 54a facing upward. The hub 54 covers the rotor yoke 52, the magnet 51, the bush 53, the stator 70, the bearing device 80, and the like from above. Thus, the hub 54 suppresses foreign matters from entering a more inner side than of the hub 54.

The plurality of blades 55 have substantially the same shape and extend outward from the side wall 54b of the hub 54. The plurality of blades 55 are arranged at substantially regular intervals in the circumferential direction of the side wall 54b of the hub 54. Each of the plurality of blades 55 is formed to generate an airflow flowing along the axial direction from the upper side to the lower side in the internal space of the casing 11 when the impeller 56 rotates.

The bush 53 is made of, for example, a soft magnetic material. A through hole 53h axially penetrating the bush 53 is formed at the center in the radial direction of the bush 53. The shaft 10 is attached to the bush 53 by, for example, press-fitting the protrusion part 10a of the shaft 10 into this through hole 53h. A recess part 53c recessed inward is formed at an upper part of the bush 53.

The rotor yoke 52 has a cup-like shape with a bottomed substantially inverted U-shaped cross section, and is made of, for example, a soft magnetic material. The rotor yoke 52 includes a plate-shaped base 52a perpendicular to the axial direction, and a tubular (cylindrical) side wall 52b extending substantially along the axial direction from an outer end part of the base 52a. The rotor yoke 52 is disposed with the base 52a facing upward. The rotor yoke 52 covers the magnet 51, the stator 70, the bearing device 80, and the like from above. Thus, the rotor yoke 52 suppresses foreign matters from entering a more inner side than of the rotor yoke 52.

A hole having a circular shape is formed at the center in the radial direction of the base 52a of the rotor yoke 52 when viewed from the axial direction. This hole is defined by an inner peripheral surface 52ai of the base 52a. The inner peripheral surface 52ai of the base 52a and the vicinity of the inner peripheral surface 52ai are caulked and fixed at the upper part of the bush 53. As a result, the recess part 53c described above is formed at the upper part of the bush 53. An upper part of an outer peripheral surface of the side wall 52b of the rotor yoke 52 is fixed at an inner peripheral surface of the side wall 54b of the hub 54 of the impeller 56 using, for example, an adhesive. In this manner, the rotor yoke 52 is fixed at the inner peripheral surface of the impeller 56.

The magnet 51 is formed in an annular shape as viewed from the axial direction, and is formed in a cylindrical shape in the present embodiment. An outer peripheral surface of the magnet 51 is fixed at an inner peripheral surface of the side wall 52b of the rotor yoke 52 via, for example, an adhesive. The magnet 51 is magnetized to the N pole and the S pole alternately in the circumferential direction. In the radial direction, an inner peripheral surface 51i of the magnet 51 is present more outside than the stator 70 and faces the outer peripheral surface 710 of the stator core 71 via an air gap.

In the blower 1, when the plurality of coils 73 are supplied with current, magnetic interaction occurs between the outer peripheral surface 710 of the stator core 71 and the inner peripheral surface 51i of the magnet 51, and a magnetic circuit is formed in the blower 1. The shaft 10 rotates by this magnetic circuit, and the rotor 50 including the impeller 56 rotates about the shaft 10 along with the rotation of this shaft 10. That is, the rotor 50 including the impeller 56 rotates relative to the bearing device 80 including the stator 70 and the sleeve 81. In this manner, the blower 1 is configured as an outer rotor type. When the impeller 56 rotates, an airflow flowing along the axial direction from the upper side (one side) toward the lower side (the other side) in the internal space of the casing 11 is generated.

Next, the bearing device 80 will be described in more detail.

As illustrated in FIG. 1, in the bearing device 80, the first ball bearing 20 is disposed in the vicinity of the protrusion part 10a of the shaft 10. As illustrated in FIG. 1, the base 54a of the hub 54 is present at an upper side of the protrusion part 10a. Therefore, the first ball bearing 20 is present at a side closer to the base 54a of the hub 54 than the second ball bearing 30. That is, the first ball bearing 20 is present at a side closer to the impeller 56 than the second ball bearing 30.

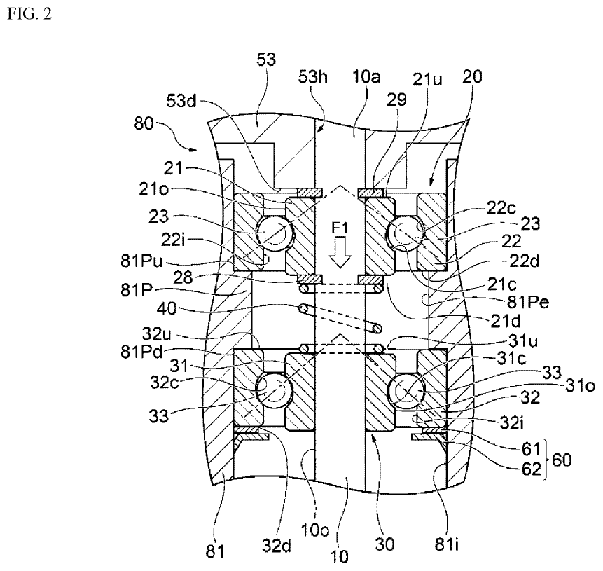

FIG. 2 is an enlarged cross-sectional view schematically illustrating the bearing device 80 when the impeller 56 is stationary. Furthermore, FIG. 2 illustrates the bearing device 80 when the impeller 56 is stationary in a case. In the case, the blower 1 is disposed such that the protrusion part 10a of the shaft 10 faces upward in the vertical direction.

As illustrated in FIG. 2, the first ball bearing 20 includes an inner ring 21, an outer ring 22, and a plurality of rolling elements (balls) 23. The shaft 10 is inserted into a through hole defined by an inner peripheral surface of the inner ring 21. The inner ring 21 is supported by a shaft 10 penetrating the through hole of the inner ring 21. The inner ring 21 is supported at a part close to the impeller 56 at the shaft 10. A recess part 21c recessed in an arc shape inward as viewed from the radial direction is formed at the center in the axial direction of the outer peripheral surface 210 of the inner ring 21. An outer peripheral surface of the outer ring 22 is fixed at an inner peripheral surface 81i of the sleeve 81 using, for example, an adhesive. A recess part 22c recessed in an arc shape outward as viewed from the radial direction is formed at the center in the axial direction of the inner peripheral surface 22i of the outer ring 22. The plurality of rolling elements 23 are sandwiched and supported by the recess part 21c of the inner ring 21 and the recess part 22c of the outer ring 22. By interposing the plurality of rolling elements 23 between the inner ring 21 and the outer ring 22 in this manner, the inner ring 21 rotates together with the shaft 10 with respect to the outer ring 22 fixed at the sleeve 81.

The second ball bearing 30 has the same configuration as the first ball bearing 20. The shaft 10 is inserted into a through hole defined by an inner peripheral surface of an inner ring 31 of the second ball bearing 30. The inner ring 31 is supported by a shaft 10 penetrating the through hole of the inner ring 31. The inner ring 31 is supported at a part farther from the impeller 56 than the inner ring 21 at the shaft 10. An outer peripheral surface of an outer ring 32 is substantially in surface contact with the inner peripheral surface 81i of the sleeve 81. A plurality of rolling elements 33 are sandwiched and supported by a recess part 31c of the inner ring 31 and a recess part 32c of the outer ring 32. By interposing the plurality of rolling elements 33 between the inner ring 31 and the outer ring 32 in this manner, the inner ring 31 rotates together with the shaft 10 with respect to the outer ring 32.

Note that in the present embodiment, the outer ring 22 of the first ball bearing 20 is fixed at the sleeve 81 by adhesion, but the inner ring 21 of the first ball bearing 20 and the inner ring 31 and the outer ring 32 of the second ball bearing 30 are each clearance-fitted. Specifically, the inner ring 21 of the first ball bearing 20 and the inner ring 31 of the second ball bearing 30 are each clearance-fitted into the shaft 10, and the outer ring 32 of the second ball bearing 30 is clearance-fitted into the sleeve 81.

The sleeve 81 includes a step part 81P protruding inward in the radial direction. The step part 81P is present between the outer ring 22 of the first ball bearing 20 and the outer ring 32 of the second ball bearing 30 in the axial direction. In the radial direction, an end surface 81Pe of the step part 81P is present at the same position as the inner peripheral surface 22i of the outer ring 22 of the first ball bearing 20 or more outside than the inner peripheral surface 22i, and is present at the same position as the inner peripheral surface 32i of the outer ring 32 of the second ball bearing 30 or more outside than the inner peripheral surface 32i. An upper surface 81Pu of the step part 81P is in contact with a lower surface 22d of the outer ring 22 of the first ball bearing 20. A lower surface 81Pd of the step part 81P is in contact with an upper surface 32u of the outer ring 32 of the second ball bearing 30. Note that in the present embodiment, the step part 81P is integrated with the sleeve 81 but may be formed of a separate member having a substantially cylindrical shape fixed at the inner peripheral surface 81i of the sleeve 81 with a method such as adhesion.

The fixed part 60 is positioned lower than (at the other side of) the step part 81P. In other words, the step part 81P is present upper than (at one side of) the fixed part 60. The fixed part 60 is fixed at the inner peripheral surface 81i of the sleeve 81 and protrudes inward. In the present embodiment, the fixed part 60 includes a washer 62 fixed at the inner peripheral surface 81i of the sleeve 81 and protruding inward, and a spacer 61 disposed at an upper surface of the washer 62. The lower surface 32d of the outer ring 32 of the second ball bearing 30 is in contact with an upper surface of the spacer 61. Each of the spacer 61 and the washer 62 has a ring shape, and the shaft 10 is inserted inside an inner peripheral surface of the spacer 61 and inside an inner peripheral surface of the washer 62. Note that the fixed part 60 is not limited to this, and for example, may include only the washer 62 or may include only the spacer 61 fixed at the inner peripheral surface 81i.

In the present embodiment, the outer ring 32 of the second ball bearing 30 is sandwiched between the step part 81P and the fixed part 60 to be restricted in movement in the axial direction. Note that the movement in the axial direction of the outer ring 32 may be restricted by bonding of the outer ring 32 of the second ball bearing 30 to the inner peripheral surface 81i of the sleeve 81 with an adhesive or the like.

The first flange part 28 is fixed at a part between the inner ring 21 of the first ball bearing 20 and the inner ring 31 of the second ball bearing 30 at the shaft 10, and sticks out radially outward from the shaft 10. In the present embodiment, the first flange part 28 is a washer, and is fitted into a groove formed in an outer peripheral surface 100 of the shaft 10, thus being supported by the shaft 10. Note that the configuration of the first flange part 28 is not limited to this, and may be a part integrally molded with, for example, the shaft 10 in a flange shape. In the present embodiment, the first flange part 28 is present immediately below the inner ring 21 of the first ball bearing 20, and is in contact with a lower surface 21d of the inner ring 21 of the first ball bearing 20 when the impeller 56 is stationary, but needs not be in contact with the lower surface 21d.

The first spring 40 is disposed between a lower surface of the first flange part 28 and an upper surface 31u of the inner ring 31 of the second ball bearing 30. The shaft 10 penetrates the inside of the first spring 40. That is, the first spring 40 surrounds a part of the outer peripheral surface 100 of the shaft 10.

In the present embodiment, the washer 29 is supported by the shaft 10. For example, the washer 29 is supported by the shaft 10 by being fitted into a groove formed at the outer peripheral surface 100 of the shaft 10. The shaft 10 is inserted into the through hole 53h of the bush 53.

When the blower 1 is disposed such that the protrusion part 10a of the shaft 10 faces upward in the vertical direction, a load F1 by the rotor 50 acts at the shaft 10 from the upper side toward the lower side as indicated by an arrow in FIG. 2 when the impeller 56 is stationary. Thus, the shaft 10 and the inner ring 21 of the first ball bearing 20 supported by the shaft 10 move downward. As described above, the outer ring 22 of the first ball bearing 20 is fixed at the sleeve 81. Therefore, the inner ring 21 of the first ball bearing 20 is positioned relatively downward with respect to the outer ring 22. Therefore, when the impeller 56 is stationary, the rolling elements 23 of the first ball bearing 20 come into contact with an upper region of the recess part 21c of the inner ring 21 and a lower region of the recess part 22c of the outer ring 22. That is, when the impeller 56 is stationary, a preload acts on the first ball bearing 20 in a state. In the state, the straight line connecting contact points between the inner ring 21 and the outer ring 22 and the rolling elements 23 is inclined with respect to the radial direction so as to extend outward in the radial direction as going downward, as indicated by the dash-dot line in FIG. 2.

Since the first spring 40 is disposed at the upper surface 31u of the inner ring 31 of the second ball bearing 30, the inner ring 31 supported by the shaft 10 also tends to move downward along with the shaft 10 moving downward upon receiving the load F1 by the rotor 50. As described above, the outer ring 32 of the second ball bearing 30 is restricted in movement in the axial direction. Therefore, the inner ring 31 of the second ball bearing 30 is positioned relatively downward with respect to the outer ring 32. Therefore, when the impeller 56 is stationary, the rolling elements 33 of the second ball bearings 30 come into contact with an upper region of the recess part 31c of the inner ring 31 and a lower region of the recess part 32c of the outer ring 32. That is, when the impeller 56 is stationary, a preload acts on the second ball bearing 30 in a state. In the state, the straight line connecting contact points between the inner ring 31 and the outer ring 32 and the rolling elements 33 is inclined with respect to the radial direction so as to extend outward in the radial direction as going downward, as indicated by the dash-dot line in FIG. 2.

In this manner, in the bearing device 80, when the impeller 56 is stationary, the preload applied to the first ball bearing 20 and the second ball bearing 30 is in a parallel combination. In the parallel combination, the preload acts in a state. In the state, the straight line connecting the contact points between the inner ring and the outer ring and the rolling elements of each is inclined with respect to the radial direction so as to extend outward in the radial direction as going downward.

The first spring 40 is in contact with the first flange part 28 supported by the shaft 10 and is not in contact with the first ball bearing 20. Therefore, the biasing force of the first spring 40 is blocked from being transmitted to the first ball bearing 20 by the first flange part 28 supported by the shaft 10. That is, when the impeller 56 is stationary, the first ball bearing 20 is applied with substantially only a preload caused by the load F1 by the rotor 50.

Next, the bearing device 80 when the impeller 56 is rotating will be described.

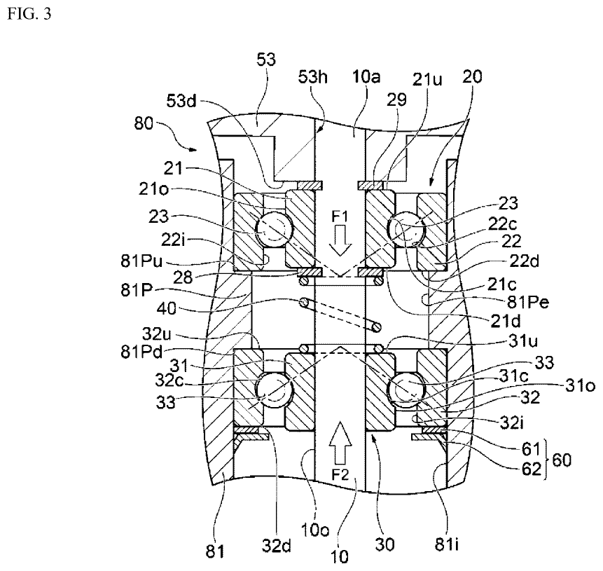

FIG. 3 is an enlarged cross-sectional view schematically illustrating the bearing device 80 when the impeller 56 is rotating. Furthermore, FIG. 3 illustrates the bearing device 80 when the impeller 56 is rotating in a case. In the case, the blower 1 is disposed such that the protrusion part 10a of the shaft 10 faces upward in the vertical direction.

As indicated by an arrow in FIG. 3, when the impeller 56 rotates in a case. In the case, the blower 1 is disposed such that the protrusion part 10a of the shaft 10 faces upward in the vertical direction, in addition to the load F1 by the rotor 50 from the upper side toward the lower side, a thrust force F2 acts on the shaft 10. This thrust force F2 acts from the lower side (other side) toward the upper side (one side) due to the airflow from the upper side toward the lower side generated by the rotation of the impeller 56.

Specifically, when the rotation speed of the impeller 56 increases (when the impeller 56 is rotating at a high speed), the thrust force F2 becomes larger than the load F1 by the rotor 50, and as a result, the shaft 10 and the first flange part 28 supported by the shaft 10 move upward by this thrust force F2. Then, as a result of the first flange part 28 moving upward, the inner ring 21 of the first ball bearing 20 is pushed from the lower side (other side) toward the upper side (one side) by the first flange part 28 in contact with the lower surface 21d of the inner ring 21, and moves upward. The outer ring 22 of the first ball bearing 20 is fixed at the sleeve 81. Therefore, the inner ring 21 is positioned relatively upward with respect to the outer ring 22. Therefore, when the impeller 56 is rotating at a high speed, the rolling elements 23 of the first ball bearing 20 come into contact with a lower region of the recess part 21c of the inner ring 21 and an upper region of the recess part 22c of the outer ring 22. That is, when the impeller 56 is rotating at a high speed, a preload acts on the first ball bearing 20 in a state. In the state, the straight line connecting contact points between the inner ring 21 and the outer ring 22 and the rolling elements 23 is inclined with respect to the radial direction so as to extend outward in the radial direction as going upward, as indicated by the dash-dot line in FIG. 3.

Note that the rotation speed of the impeller 56 at a high speed is not particularly limited, but may be, for example, 8000 rpm or more, may be 10000 rpm or more, may be 15000 rpm or more, or 30000 rpm or more.

When the impeller 56 is rotating at a high speed, the inner ring 31 of the second ball bearing 30 supported by the shaft 10 tends to move upward together with the shaft 10 by the thrust force F2. However, since the pushing force of the inner ring 31 to the first spring 40 also increases accordingly, the first spring 40 repels and pushes the inner ring 31 downward. As a result, the inner ring 31 is held at a lower position. Since the outer ring 32 of the second ball bearing 30 is restricted in movement in the axial direction, the inner ring 31 is positioned relatively downward with respect to the outer ring 32. Therefore, when the impeller 56 is rotating at a high speed, the rolling elements 33 of the second ball bearing 30 come into contact with the upper region of the recess part 31c of the inner ring 31 and the lower region of the recess part 32c of the outer ring 32. That is, when the impeller 56 is rotating at a high speed, a preload acts on the second ball bearing 30 in a state. In the state, the straight line connecting contact points between the inner ring 31 and the outer ring 32 and the rolling elements 33 is inclined with respect to the radial direction so as to extend outward in the radial direction as going upward, as indicated by the dash-dot line in FIG. 3.

In this manner, in the bearing device 80, the preload applied to the first ball bearing 20 and the second ball bearing 30 when the impeller 56 is rotating at a high speed is in what is called a front combination.

Note that although not particularly limited, in the bearing device 80 in the present embodiment, the maximum value of the load (biasing force) by the first spring 40 is smaller than the load F1 by the rotor 50 when the blower 1 is disposed such that the protrusion part 10a of the shaft 10 faces upward in the vertical direction. Here, as described above, the thrust force F2 when the impeller 56 is rotating at a high speed is larger than the load F1 by the rotor 50. That is, in the present embodiment, the load by the first spring 40 is smaller than the thrust force F2 at the time of high speed rotation. Therefore, in the bearing device 80, the biasing force by the first spring 40 is suppressed from acting against the thrust force F2 particularly at the time of high speed rotation.

As described above, the blower 1 of the present embodiment includes: the shaft 10; the sleeve 81 internally accommodating the part of the shaft 10 (substantially the part excluding the protrusion part 10a); an impeller 56 rotatably supported at one side in an axial direction of the shaft 10, the impeller 56 generating, by rotating, an airflow from one side in the axial direction toward another side in the axial direction; the first ball bearing 20 including an inner ring 21 supported by the part close to the impeller 56 at the shaft 10 and an outer ring 22 fixed at an inner peripheral surface 81i of the sleeve 81; the second ball bearing 30 with an inner ring 31 supported at the part farther from the impeller 56 than the inner ring 21 of the first ball bearing 20 at the shaft 10; the first flange part 28 supported at the part between the inner ring 21 of the first ball bearing 20 and the inner ring 31 of the second ball bearing 30 at the shaft 10 and sticking outward in the radial direction perpendicular to the axial direction from the shaft 10; and the first spring 40 disposed between the first flange part 28 and the inner ring 31 of the second ball bearing 30. Then, in the blower 1, the first flange part 28 pushes the inner ring 21 of the first ball bearing 20 from the other side toward the one side when the impeller 56 rotates.

Since the first ball bearing 20 is present at a position close to the impeller 56 and is present at a position far from the base part 13 of the casing 11 supporting the bearing device 80, large moment caused by the rotation of the impeller 56 acts on the first ball bearing 20 particularly when the impeller 56 is rotating at a high speed. However, according to such the blower 1, as described above, the first ball bearing 20 can be applied with a preload only by the thrust force from the lower side toward the upper side when the impeller 56 is rotating. That is, in the blower 1, even when the impeller 56 is rotated at a high speed, it is not necessary to apply the biasing force of the spring against the thrust force, and thus application of an excessive surface pressure exceeding a prescribed value to the first ball bearing 20 is suppressed. Therefore, according to the blower 1, even when relatively large moment acts on the first ball bearing 20 by the high speed rotation of the impeller 56, it is possible to apply a preload to the first ball bearing 20 while suppressing the first ball bearing 20 from being applied with an excessive load.

On the other hand, the second ball bearing 30 present at a position at the lower side when the blower 1 is disposed such that the protrusion part 10a of the shaft 10 faces upward in the vertical direction is present at a position far from the impeller 56 and is present at a position close to the base part 13 of the casing 11 supporting the bearing device 80. Therefore, even when the impeller 56 is rotating at a high speed, relatively small moment acts on the second ball bearing 30. Therefore, even when a preload is applied to the second ball bearing 30 by the biasing force of the first spring 40 when the impeller 56 is rotating at a high speed, the load on the second ball bearing 30 is relatively small.

In this manner, according to the blower 1, even when the impeller 56 is rotating at a high speed, a preload can be applied to both the first ball bearing 20 and the second ball bearing 30 without applying an excessive load, and therefore the rotation speed of the impeller 56 can be increased.

Since in the blower 1, as described above, only the load F1 by the rotor 50 acts on the first ball bearing 20 when the impeller 56 is stationary (i.e., the biasing force by the spring does not act on the first ball bearing 20), the preload applied to the first ball bearing 20 is reduced. In this manner, in the blower 1, since the resistance when the stationary impeller 56 is about to rotate is reduced, the impeller 56 can start to rotate more smoothly.

In the blower 1, as described above, an upper surface 21u of the inner ring 21 of the first ball bearing 20 is in contact with the washer 29. Therefore, the upper surface 21u of the inner ring 21 and a lower surface 53d of the bush 53 do not relatively move (e.g., rotate) in a state of being in direct contact with each other, and generation of noise and wear of the inner ring 21 are suppressed.

### Second Embodiment

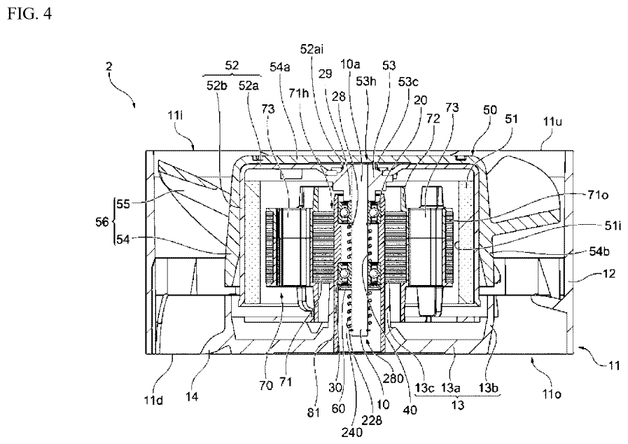

Next, a blower according to the second embodiment will be described. FIG. 4 is an axial cross-sectional view illustrating a blower 2 according to the present embodiment. As illustrated in FIG. 4, the blower 2 has the same configuration as the blower 1 except that a part of the configuration of a bearing device 280 is different from the configuration of the bearing device 80 of the blower 1. Therefore, hereinafter, only differences between the blower 2 and the blower 1 will be described, and the other configurations will be denoted by the same reference signs as the reference signs in the first embodiment and description of the other configurations will be omitted.

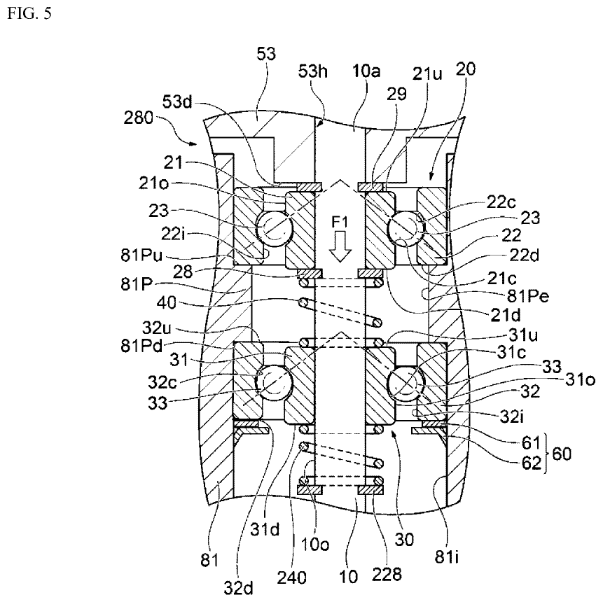

FIG. 5 is an enlarged cross-sectional view schematically illustrating the bearing device 280 when the impeller 56 is stationary. Furthermore, FIG. 5 illustrates the bearing device 80 when the impeller 56 is stationary in a case. In the case, the blower 2 is disposed such that the protrusion part 10a of the shaft 10 faces upward in the vertical direction. As illustrated in FIG. 5, the bearing device 280 includes a second flange part 228 and a second spring 240.

The second flange part 228 is supported by a part lower than (at the other side of) the inner ring 31 of the second ball bearing 30 at the shaft 10, and sticks out radially outward from the shaft 10. In the present embodiment, the second flange part 228 is a washer, and is fitted into a groove formed in the outer peripheral surface 100 of the shaft 10. Note that the configuration of the second flange part 228 is not limited to this, and may be a part integrally molded with, for example, the shaft 10 in a flange shape.

The second spring 240 is present immediately below the inner ring 31 of the second ball bearing 30, and is disposed between an upper surface of the second flange part 228 and a lower surface 31d of the inner ring 31 of the second ball bearing 30. The shaft 10 penetrates the inside of the second spring 240. That is, the second spring 240 surrounds a part of the outer peripheral surface 100 of the shaft 10.

When the impeller 56 is stationary in a case with the blower 2 being disposed such that the protrusion part 10a of the shaft 10 faces upward in the vertical direction, a preload acts on the first ball bearing 20 in a state. In the state, the straight line connecting contact points between the inner ring 21 and the outer ring 22 and the rolling elements 23 is inclined with respect to the radial direction so as to extend inward in the radial direction as going upward, by the load F1 by the rotor 50, similarly to the bearing device 80, as indicated by the dash-dot line in FIG. 5. When the impeller 56 is stationary, only the load F1 by the rotor 50 acts on the first ball bearing 20 similarly to the bearing device 80.

The inner ring 31 of the second ball bearing 30 moves downward together with the shaft 10 by the load F1 by the rotor 50 when the impeller 56 is stationary. However, at a certain time point when the inner ring 31 moves downward, the biasing force against the inner ring 31 by the first spring 40 and the biasing force against the inner ring 31 by the second spring 240 disposed between the inner ring 31 and the second flange part 228 are balanced, and the inner ring 31 is held at the position at this time point. Similarly to the case of the bearing device 80, the outer ring 32 of the second ball bearing 30 is restricted in movement in the axial direction. Therefore, the inner ring 31 of the second ball bearing 30 is positioned relatively downward with respect to the outer ring 32. Therefore, when the impeller 56 is stationary, the rolling elements 33 of the second ball bearings 30 come into contact with the upper region of the recess part 31c of the inner ring 31 and the lower region of the recess part 32c of the outer ring 32. That is, when the impeller 56 is stationary, a preload acts on the second ball bearing 30 in a state. In the state, the straight line connecting contact points between the inner ring 31 and the outer ring 32 and the rolling elements 33 is inclined with respect to the radial direction so as to extend outward in the radial direction as going downward, as indicated by the dash-dot line in FIG. 5.

In this manner, in the bearing device 280, when the impeller 56 is stationary, the preload applied to the first ball bearing 20 and the second ball bearing 30 is in a parallel combination. In the parallel combination, the preload acts in a state. In the state, the straight line connecting the contact points between the inner ring and the outer ring and the rolling elements of each is inclined with respect to the radial direction so as to extend outward in the radial direction as going downward.

Next, the bearing device 280 when the impeller 56 is rotating will be described.

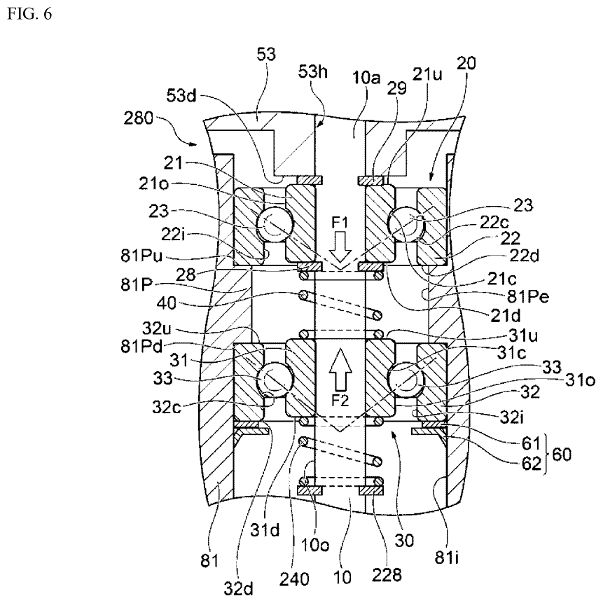

FIG. 6 is an enlarged cross-sectional view schematically illustrating the bearing device 280 when the impeller is rotating. Furthermore, FIG. 6 illustrates the bearing device 280 when the impeller 56 is rotating in a case. In the case, the blower 1 is disposed such that the protrusion part 10a of the shaft 10 faces upward in the vertical direction.

As indicated by the arrow in FIG. 6, when the impeller 56 is rotating at a high speed, the thrust force F2 becomes larger than the load F1 by the rotor 50, and as a result, the shaft 10 and the first flange part 28 supported by the shaft 10 move upward by this thrust force F2. Then, as a result of the first flange part 28 moving upward, the inner ring 21 of the first ball bearing 20 is pushed from the lower side (other side) toward the upper side (one side) by the first flange part 28 in contact with the lower surface 21d of the inner ring 21, and moves upward. Similarly to the first embodiment, the outer ring 22 of the first ball bearing 20 is fixed (bonded with an adhesive) to the sleeve 81. Therefore, the inner ring 21 is positioned relatively upward with respect to the outer ring 22. Therefore, when the impeller 56 is rotating at a high speed, the rolling elements 23 of the first ball bearing 20 come into contact with the lower region of the recess part 21c of the inner ring 21 and the upper region of the recess part 22c of the outer ring 22. That is, when the impeller 56 is rotating at a high speed, a preload acts on the first ball bearing 20 in a state. In the state, the straight line connecting contact points between the inner ring 21 and the outer ring 22 and the rolling elements 23 is inclined with respect to the radial direction so as to extend outward in the radial direction as going upward, as indicated by the dash-dot line in FIG. 6.

When the impeller 56 is rotating at a high speed, the inner ring 31 of the second ball bearing 30 supported by the shaft 10 moves upward together with the shaft 10 by the thrust force F2. When the rotation speed of the impeller 56 increases and the thrust force F2 increases, the inner ring 31 moves further upward. Then, at a time point when the inner ring 31 moves upward to some extent, the biasing force with respect to the inner ring 31 by the first spring 40 and the biasing force with respect to the inner ring 31 by the second spring 240 attached to the second flange part 228 and the inner ring 31 are balanced, and the inner ring 31 is held at a position at this time point. The outer ring 32 of the second ball bearing 30 is restricted in movement in the axial direction. Therefore, the inner ring 31 of the second ball bearing 30 is positioned relatively upward with respect to the outer ring 32. Therefore, when the impeller 56 is rotating at a high speed, the rolling elements 33 of the second ball bearing 30 come into contact with a lower region of the recess part 31c of the inner ring 31 and an upper region of the recess part 32c of the outer ring 32. That is, when the impeller 56 is rotating at a high speed, a preload acts on the second ball bearing 30 in a state. In the state, the straight line connecting contact points between the inner ring 31 and the outer ring 32 and the rolling elements 33 is inclined with respect to the radial direction so as to extend outward in the radial direction as going upward, as indicated by the dash-dot line in FIG. 6.

In this manner, in the bearing device 280, when the impeller 56 is rotating at a high speed, the preload applied to the first ball bearing 20 and the second ball bearing 30 is in a parallel combination (i.e., a parallel combination in a direction opposite to when being in a stationary state). In the parallel combination, the preload acts in a state. In the state, the straight line connecting the contact points between the inner ring and the outer ring and the rolling elements of each is inclined with respect to the radial direction so as to extend outward in the radial direction as going upward.

Note that although not particularly limited, in the present embodiment, the change amount of the load (biasing force) by the first spring 40 and the second spring 240 when the deflection amounts of the first spring 40 and the second spring 240 change by an axial gap of the first ball bearing 20 and/or the second ball bearing 30 is preferably larger than the weight of the inner ring 31 of the second ball bearing 30.

As described above, the blower 2 of the present embodiment includes: the shaft 10; the sleeve 81 internally accommodating the part of the shaft 10 (substantially the part excluding the protrusion part 10a); an impeller 56 rotatably supported at one side in an axial direction of the shaft 10, the impeller 56 generating, by rotating, an airflow from one side in the axial direction toward another side in the axial direction; the first ball bearing 20 including an inner ring 21 supported by the part close to the impeller 56 at the shaft 10 and an outer ring 22 fixed at an inner peripheral surface 81i of the sleeve 81; the second ball bearing 30 with an inner ring 31 supported at the part farther from the impeller 56 than the inner ring 21 of the first ball bearing 20 at the shaft 10; the first flange part 28 supported at the part between the inner ring 21 of the first ball bearing 20 and the inner ring 31 of the second ball bearing 30 at the shaft 10 and sticking outward in the radial direction perpendicular to the axial direction from the shaft 10; and the first spring 40 disposed between the first flange part 28 and the inner ring 31 of the second ball bearing 30. Then, in the blower 2, the first flange part 28 pushes the inner ring 21 of the first ball bearing 20 from the other side toward the one side when the impeller 56 rotates.

Therefore, according to the blower 2, for the same reason as the blower 1, the rotation speed of the impeller 56 can be increased, and the impeller 56 can start to rotate smoothly. Furthermore, since the blower 2 includes the washer 29 similarly to the first embodiment, it is possible to suppress noise from being generated or the inner ring 21 from being worn when the impeller 56 is rotating.

In the blower 2, since the inner ring 31 of the second ball bearing 30 is supported in a state of being sandwiched from up and down by the first spring 40 and the second spring 240, the impact absorption property of the second ball bearing 30 to the inner ring 31 is particularly excellent.

### Third Embodiment

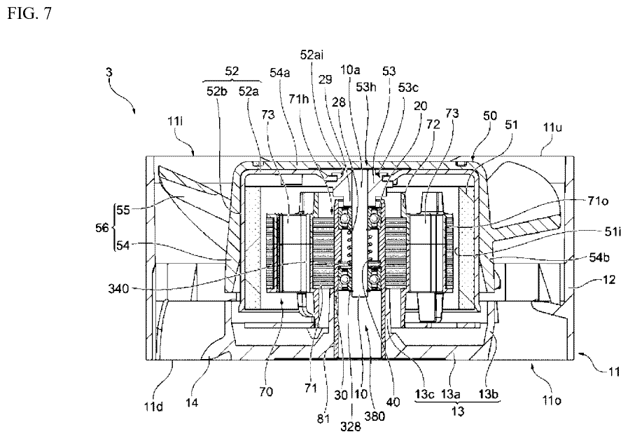

Next, a blower according to the third embodiment will be described. FIG. 7 is an axial cross-sectional view illustrating a blower 2 according to the present embodiment. As illustrated in FIG. 7, the blower 3 has the same configuration as the blower 1 except that a part of the configuration of a bearing device 380 is different from the configuration of the bearing device 80 of the blower 1. Therefore, hereinafter, only differences between the blower 3 and the blower 1 will be described, and the other configurations will be denoted by the same reference signs as the reference signs in the first embodiment and description of the other configurations will be omitted.

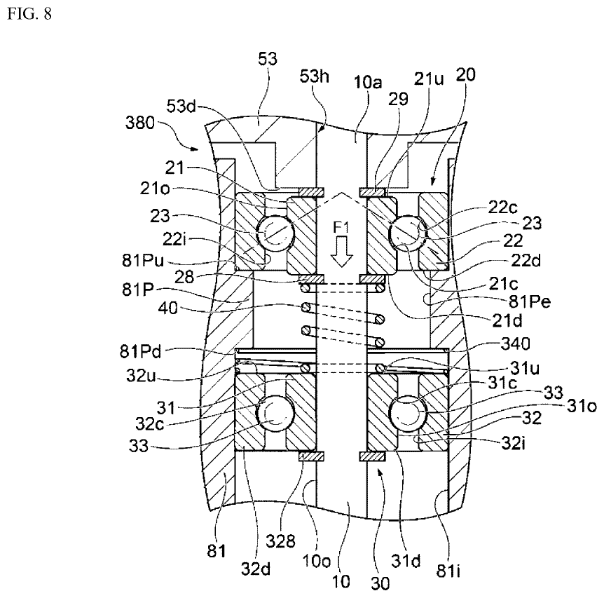

FIG. 8 is an enlarged cross-sectional view schematically illustrating the bearing device 380 when the impeller 56 is stationary. Furthermore, FIG. 8 illustrates the bearing device 380 when the impeller 56 is stationary in a case with the blower 3 being disposed such that the protrusion part 10a of the shaft 10 faces upward in the vertical direction. As illustrated in FIG. 8, the bearing device 380 includes a second flange part 328 and a third spring 340.

The second flange part 328 is supported by a part lower than (at the other side of) the inner ring 31 of the second ball bearing 30 at the shaft 10, and sticks out radially outward from the shaft 10. In the present embodiment, the second flange part 328 is a washer, and is fitted into a groove formed in the outer peripheral surface 100 of the shaft 10. In the present embodiment, when the impeller 56 is stationary, the second flange part 328 is in contact with the lower surface 31d of the inner ring 31 of the second ball bearing 30, but needs not be in contact with the lower surface 31d. Note that the configuration of the second flange part 328 is not limited to this, and may be a part integrally molded with, for example, the shaft 10 in a flange shape.

The third spring 340 is disposed between the step part 81P of the sleeve 81 and the outer ring 32 of the second ball bearing 30 in the axial direction. That is, the third spring 340 is disposed between a lower surface 81Pd of the step part 81P of the sleeve 81 and the upper surface 32u of the outer ring 32 of the second ball bearing 30. In the present embodiment, the third spring 340 includes one spring, but may include two or more spring pieces arranged at equal intervals in the circumferential direction.

Note that unlike the bearing devices 80 and 280, the bearing device 380 does not include the fixed part 60.

When the impeller 56 is stationary in a case with the blower 3 being disposed such that the protrusion part 10a of the shaft 10 faces upward in the vertical direction, a preload acts on the first ball bearing 20 in a state. In the state, the straight line connecting contact points between the inner ring 21 and the outer ring 22 and the rolling elements 23 is inclined with respect to the radial direction so as to extend outward in the radial direction as going downward, by the load F1 by the rotor 50, similarly to the bearing device 80, as indicated by the dash-dot line in FIG. 8. When the impeller 56 is stationary, only the load F1 by the rotor 50 acts on the first ball bearing 20 similarly to the bearing device 80.

When the impeller 56 is stationary, the inner ring 31 of the second ball bearing 30 supported by the shaft 10 moves downward together with the shaft 10 by the load F1 by the rotor 50. On the other hand, the outer ring 32 of the second ball bearing 30 moves downward by the biasing force of the third spring 340. Therefore, the inner ring 31 and the outer ring 32 of the second ball bearing 30 are disposed at substantially the same position in the axial direction. Therefore, the second ball bearing 30 is applied with substantially no preload when the impeller 56 is stationary.

In this manner, the bearing device 380 is in a combination. In the combination, the preload acts on the first ball bearing 20 in a state. In the state, the straight line connecting the contact points between the inner ring and the outer ring and the rolling element is inclined with respect to the radial direction so as to extend inward in the radial direction as going upward, and the preload does not act on the second ball bearing 30 when the impeller 56 is stationary.

Next, the bearing device 380 when the impeller 56 is rotating will be described.

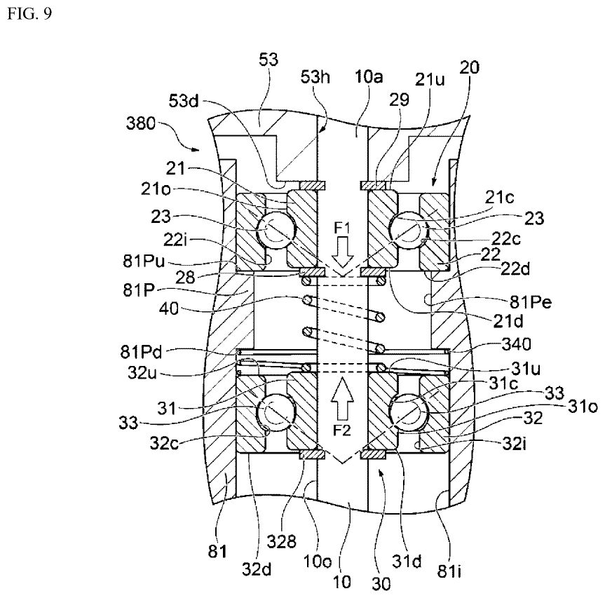

FIG. 9 is an enlarged cross-sectional view schematically illustrating the bearing device 380 when the impeller is rotating. Furthermore, FIG. 9 illustrates the bearing device 380 when the impeller 56 is rotating in a case. In the case, the blower 3 is disposed such that the protrusion part 10a of the shaft 10 faces upward in the vertical direction.

As indicated by the arrow in FIG. 9, when the impeller 56 is rotating at a high speed, the thrust force F2 becomes larger than the load F1 by the rotor 50, and as a result, the shaft 10 and the first flange part 28 supported by the shaft 10 move upward by this thrust force F2. Then, as a result of the first flange part 28 moving upward, the inner ring 21 of the first ball bearing 20 is pushed from the lower side (other side) toward the upper side (one side) by the first flange part 28 in contact with the lower surface 21d of the inner ring 21, and moves upward. Similarly to the first embodiment, the outer ring 22 of the first ball bearing 20 is fixed (bonded with an adhesive) to the sleeve 81. Therefore, the inner ring 21 is positioned relatively upward with respect to the outer ring 22. Therefore, when the impeller 56 is rotating at a high speed, the rolling elements 23 of the first ball bearing 20 come into contact with the lower region of the recess part 21c of the inner ring 21 and the upper region of the recess part 22c of the outer ring 22. That is, when the impeller 56 is rotating at a high speed, a preload acts on the first ball bearing 20 in a state. In the state, the straight line connecting contact points between the inner ring 21 and the outer ring 22 and the rolling elements 23 is inclined with respect to the radial direction so as to extend outward in the radial direction as going upward, as indicated by the dash-dot line in FIG. 9.

When the impeller 56 is rotating at a high speed, the second flange part 328 moves upward integrally with the shaft 10 by the thrust force F2. As a result, the second flange part 328 comes into contact with the lower surface 31d of the inner ring 31 of the second ball bearing 30, and moves (pushes) the inner ring 31 from the lower side (other side) to the upper side (one side). When the rotation speed of the impeller 56 increases and the thrust force F2 increases, the inner ring 31 is moved further upward by the second flange part 328. At this time, the inner ring 31 is held at a position in contact with the second flange part 328 by the biasing force with respect to the inner ring 31 by the first spring 40. On the other hand, the outer ring 32 of the second ball bearing 30 is pushed upward via the rolling elements 33 as the inner ring 31 moves upward, but is restricted in upward movement by the biasing force of the third spring 340. Therefore, the inner ring 31 of the second ball bearing 30 is positioned relatively upward with respect to the outer ring 32. Therefore, when the impeller 56 is rotating at a high speed, the rolling elements 33 of the second ball bearing 30 come into contact with the lower region of the recess part 31c of the inner ring 31 and the upper region of the recess part 32c of the outer ring 32. That is, when the impeller 56 is rotating at a high speed, a preload acts on the second ball bearing 30 in a state. In the state, the straight line connecting contact points between the inner ring 31 and the outer ring 32 and the rolling elements 33 is inclined with respect to the radial direction so as to extend outward in the radial direction as going upward, as indicated by the dash-dot line in FIG. 9.

In this manner, in the bearing device 380, when the impeller 56 is rotating at a high speed, the preload applied to the first ball bearing 20 and the second ball bearing 30 is in a parallel combination. In the parallel combination, the preload acts in a state. In the state, the straight line connecting the contact points between the inner ring and the outer ring and the rolling elements of each is inclined with respect to the radial direction so as to extend outward in the radial direction as going upward.

Note that although not particularly limited, in the bearing device 380 in the present embodiment, each of the maximum value of the load (biasing force) by the first spring 40 and the maximum value of the load (biasing force) by the third spring 340 is smaller than the load F1 by the rotor 50 when the blower 2 is disposed such that the protrusion part 10a of the shaft 10 faces upward in the vertical direction. Here, as described above, the thrust force F2 when the impeller 56 is rotating at a high speed is larger than the load F1 by the rotor 50. That is, in the present embodiment, each of the load by the first spring 40 and the load by the third spring 340 is smaller than the thrust force F2 at the time of high speed rotation. Therefore, in the bearing device 380, the biasing force of each of the first spring 40 and the third spring 340 is suppressed from acting against the thrust force F2 particularly at the time of high speed rotation.

As described above, the blower 3 of the present embodiment includes: the shaft 10; the sleeve 81 internally accommodating the part of the shaft 10 (substantially the part excluding the protrusion part 10a); an impeller 56 rotatably supported on one side in an axial direction of the shaft 10, the impeller 56 generating, by rotating, an airflow from one side in the axial direction toward another side in the axial direction; the first ball bearing 20 including an inner ring 21 supported by the part close to the impeller 56 at the shaft 10 and an outer ring 22 fixed at an inner peripheral surface 81i of the sleeve 81; the second ball bearing 30 with an inner ring 31 supported at the part farther from the impeller 56 than the inner ring 21 of the first ball bearing 20 at the shaft 10; the first flange part 28 supported at the part between the inner ring 21 of the first ball bearing 20 and the inner ring 31 of the second ball bearing 30 at the shaft 10 and sticking outward in the radial direction perpendicular to the axial direction from the shaft 10; and the first spring 40 disposed between the first flange part 28 and the inner ring 31 of the second ball bearing 30. Then, in the blower 3, the first flange part 28 pushes the inner ring 21 of the first ball bearing 20 from the other side toward the one side when the impeller 56 rotates.

Therefore, according to the blower 3, for the same reason as the blower 1, the rotation speed of the impeller 56 can be increased, and the impeller 56 can start to rotate smoothly. Furthermore, since the blower 2 includes the washer 29 similarly to the first embodiment, it is possible to suppress noise from being generated or the inner ring 21 from being worn when the impeller 56 is rotating.

In the blower 3, since the outer ring 32 of the second ball bearing 30 is supported via the third spring 340, the impact absorption property of the second ball bearing 30 to the outer ring 32 is particularly excellent.

### Fourth Embodiment

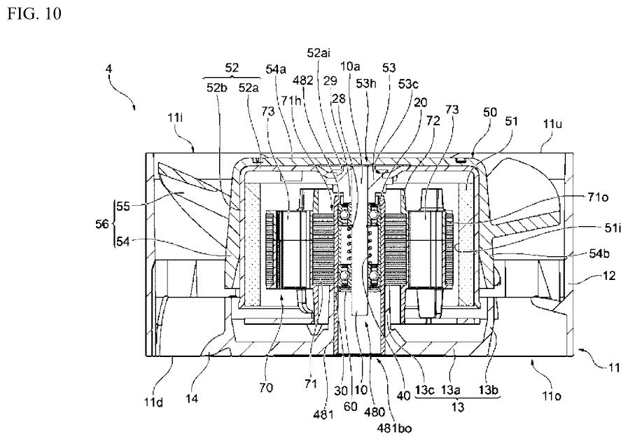

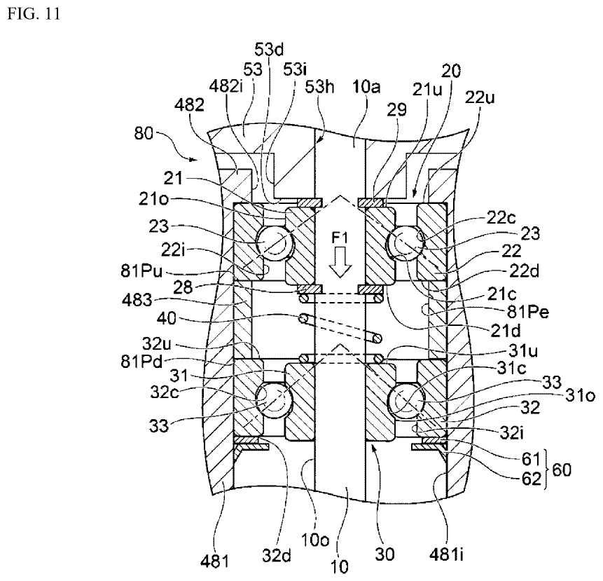

Next, a blower according to the fourth embodiment will be described. FIG. 10 is an axial cross-sectional view illustrating a blower 4 according to the present embodiment. FIG. 11 is an enlarged cross-sectional view schematically illustrating a bearing device 480 illustrated in FIG. 10 when the impeller is stationary. As illustrated in FIGS. 10 and 11, the blower 4 has the same configuration as the blower 1 except that a part of the configuration of the bearing device 480 is different from the configuration of the bearing device 80 of the blower 1. Therefore, hereinafter, only differences between the blower 4 and the blower 1 will be described, and the other configurations will be denoted by the same reference signs as the reference signs in the first embodiment and description of the other configurations will be omitted.

As illustrated in FIGS. 10 and 11, the bearing device 480 of the blower 4 has substantially the same configuration as the bearing device 80 of the blower 1, but is mainly different from the bearing device 80 of the blower 1 in that a sleeve 481 has a sticking out part 482, and that the sleeve 81 of the bearing device 80 includes the step part 81P, whereas in the bearing device 480, the sleeve 481 does not include a step part as the step part 81P and includes a spacer 483 separate from the sleeve 481. Hereinafter, these differences will be described.

As illustrated in FIGS. 10 and 11, a sticking out part 482 protruding inward in the radial direction is formed on an inner periphery of the sleeve 481. In the axial direction, the sticking out part 482 is formed at the upper end or in the vicinity of the upper end of the sleeve 481, and is formed integrally with the other part of the sleeve 481. In the radial direction, an inner peripheral surface 482i of the sticking out part 482 is positioned inside with respect to the other part of the sleeve 481. In the radial direction, the inner peripheral surface 482i of the sticking out part 482 may be present at the same position as the inner peripheral surface 22i of the outer ring 22 of the first ball bearing 20, or may be present at an inner position or an outer position with respect to the inner peripheral surface 22i. In the radial direction, a gap is formed between the inner peripheral surface 482i of the sticking out part 482 and a surface 53i of the bush 53 facing the inner peripheral surface 482i. The sticking out part 482 may be annularly formed (over the entire circumference in the circumferential direction of the sleeve 481) or may be formed in a part in the circumferential direction of the sleeve 481. An upper surface 22u of the outer ring 22 of the first ball bearing 20 (end part at one side in the axial direction of the first ball bearing 20) is in contact with a surface at a lower side (lower surface) of the sticking out part 482. Therefore, the sticking out part 482 restricts upward movement of the outer ring 22 of the first ball bearing 20.

In the present embodiment, an inner peripheral surface 481i of the sleeve 481 is formed to be flush except for the inner peripheral surface 482i of the sticking out part 482.

The bearing device 480 includes the spacer 483. The spacer 483 is a member separate from the sleeve 481. The spacer 483 is supported so as not to move with respect to the sleeve 481 in the axial direction. The spacer 483 may be press-fitted into the inner peripheral surface 482i of the sleeve 481 or may be bonded to the inner peripheral surface 482i. In this manner, since the spacer 483 is a member separate from the sleeve 481, the first ball bearing 20 can be inserted into the sleeve 481 from an lower opening 481bo of the sleeve 481 to move the first ball bearing 20 toward the upper end part of the sleeve 481, and then, the spacer 483 can be inserted into the sleeve 481 from the opening 481bo to move the spacer 483 toward the first ball bearing 20. In the axial direction, the spacer 483 is present between the first ball bearing 20 and the second ball bearing 30.

In the axial direction, the outer ring 22 of the first ball bearing 20 is sandwiched and held by the sticking out part 482 and the spacer 483, thus restricting movement in the axial direction of the first ball bearing 20 of the outer ring 22. In the present embodiment, unlike the first embodiment, the second embodiment, and the third embodiment, the outer ring 22 of the first ball bearing 20 is not fixed (e.g., adhesion using an adhesive) to the inner peripheral surface 482i of the sleeve 481, and is held by, for example, clearance fit, intermediate fit, or interference fit, and the like and disposed at the inner periphery of the sleeve 481. However, similarly to the first embodiment, the second embodiment, and the third embodiment, the outer ring 22 of the first ball bearing 20 may be fixed at the inner peripheral surface 482i of the sleeve 481.

In this manner, in the blower 4 of the present embodiment, the inner periphery of the sleeve 481 is provided with the sticking out part 482 protruding inward in the radial direction, the end part at one side of the first ball bearing 20 (the upper surface 22u of the outer ring 22 of the first ball bearing 20) is in contact with the sticking out part 482, and the outer ring 22 of the first ball bearing 20 is disposed at the inner periphery of the sleeve 481. According to such a configuration, it is possible to restrict upward movement of the outer ring 22 of the first ball bearing 20 without fixing (e.g., bonding) the outer ring 22 of the first ball bearing 20 to the sleeve 481. In the present embodiment, since the spacer 483 is further included, it is possible to restrict axial movement of the outer ring 22 of the first ball bearing 20 without fixing (e.g., bonding) the outer ring 22 of the first ball bearing 20 to the sleeve 481. The blower 4 has the same configuration as the blower 1 of the first embodiment except for these points. Therefore, even when the impeller 56 is rotating at a high speed, it is possible to apply a preload to both the first ball bearing 20 and the second ball bearing 30 without applying an excessive load, and it is possible to increase the rotation speed of the impeller 56.

The sticking out part 482 and the spacer 483 as such can also be applied to the first embodiment, the second embodiment, and the third embodiment. In such a case, it is possible to restrict axial movement of the outer ring 22 of the first ball bearing 20 (hold the axial position of the outer ring 22) without fixing the outer ring 22 of the first ball bearing 20 to the sleeve. In particular, when the sticking out part 482 and the spacer 483 are applied to the first embodiment and the second embodiment, the outer ring 22 of the first ball bearing 20 and the outer ring 32 of the second ball bearing 30 can be sandwiched by the sticking out part 482 and the fixed part 60 in the axial direction, whereby the axial movement of the outer rings 22 and 32 can be restricted. When the sticking out part 482 and the spacer 483 are applied to the first embodiment and the second embodiment, the spacer 483 needs not be supported (e.g., fixed) so as not to move with respect to the sleeve 481 in the axial direction. When the sticking out part 482 and the spacer 483 are applied to the first embodiment and the second embodiment, the three of the outer ring 22 of the first ball bearing 20, the outer ring 32 of the second ball bearing 30, and the spacer 483 can be sandwiched between the sticking out part 482 and the fixed part 60, and therefore the axial movement of the two outer rings 22 and 32 and the spacer 483 can be restricted. In this manner, when the inner ring 21 of the first ball bearing 20 and the inner ring 31 of the second ball bearing 30 are not fixed at the shaft 10, and the outer ring 22 of the first ball bearing 20, the outer ring 32 of the second ball bearing 30, and the spacer 483 are each not fixed at the sleeve 481, a fixing process such as adhesion is omitted, and therefore the blower 4 can be easily assembled. Disassembly and repair of the blower 4 become easier.

Although the present invention has been described with the above-described embodiments as examples, the present invention is not limited to this.

For example, in the above embodiments, an example has been described. In the example, the washer 29 is provided, but the washer 29 needs not be provided.

In the above embodiments, an example has been described. In the example, the step part 81P is formed at the sleeve 81, but the step part 81P needs not be formed. In this case, the outer peripheral surface of the outer ring 32 of the second ball bearing 30 may be bonded to the inner peripheral surface 81i of the sleeve 81.

In addition, those skilled in the art can appropriately modify the blower of the present invention according to known knowledge. Such modifications are of course included in the scope of the present invention as long as these modifications still include the configuration of the present invention.

### REFERENCE SIGNS LIST

1, 2, 3, 4 . . . blower, 10 . . . shaft, 20 . . . first ball bearing, 21 . . . inner ring, 22 . . . outer ring, 28 . . . first flange part, 29 . . . washer, 30 . . . second ball bearing, 31 . . . inner ring, 32 . . . outer ring, 40 . . . first spring, 50 . . . rotor, 56 . . . impeller, 60 . . . fixed part, 81, 481 . . . sleeve, 81P . . . step part, 228, 328 . . . second flange part, 240 . . . second spring, 340 . . . third spring, 482 . . . sticking out part

1. A blower comprising:
a shaft;
a sleeve internally accommodating a part of the shaft;
an impeller rotatably supported at one side in an axial direction of the shaft, the impeller generating, by rotating, an airflow from one side in the axial direction toward another side in the axial direction;
a first ball bearing including an inner ring supported by a part close to the impeller at the shaft and an outer ring fixed at an inner peripheral surface of the sleeve;
a second ball bearing with an inner ring supported at a part farther from the impeller than the inner ring of the first ball bearing at the shaft;
a first flange part supported at a part between the inner ring of the first ball bearing and the inner ring of the second ball bearing at the shaft and sticking outward in a radial direction perpendicular to the axial direction from the shaft; and
a first spring disposed between the first flange part and the inner ring of the second ball bearing,
wherein the first flange part pushes the inner ring of the first ball bearing from the other side toward the one side when the impeller rotates.

2. A blower comprising:
a shaft;
a sleeve internally accommodating a part of the shaft;
an impeller rotatably supported at one side in an axial direction of the shaft, the impeller generating, by rotating, an airflow from one side in the axial direction toward another side in the axial direction;
a first ball bearing including an inner ring supported by a part close to the impeller at the shaft and an outer ring disposed at an inner periphery of the sleeve;
a second ball bearing with an inner ring supported at a part farther from the impeller than the inner ring of the first ball bearing at the shaft;
a first flange part supported at a part between the inner ring of the first ball bearing and the inner ring of the second ball bearing at the shaft and sticking outward in a radial direction perpendicular to the axial direction from the shaft; and
a first spring disposed between the first flange part and the inner ring of the second ball bearing,
wherein the inner periphery of the sleeve is provided with a sticking out part protruding inward in the radial direction,
an end part at the one side of the first ball bearing is in contact with the sticking out part, and
the first flange part pushes the inner ring of the first ball bearing from the other side toward the one side when the impeller rotates.

3. The blower according to claim 1, wherein
the impeller forms a part of a rotor rotating with respect to the sleeve along with rotation of the shaft, and
a maximum value of a load by the first spring is smaller than a load by the rotor.

4. The blower according to claim 1, wherein
the outer ring of the second ball bearing is restricted in movement in the axial direction.

5. The blower according to claim 4 further comprising:
a fixed part fixed at an inner peripheral surface of the sleeve and sticking out inward in the radial direction,
wherein the sleeve includes a step part protruding inward in the radial direction at a part at the one side relative to the fixed part, and
the outer ring of the second ball bearing is sandwiched between the step part and the fixed part and restricted in movement in the axial direction.

6. The blower according to claim 5 further comprising:
a second flange part supported by a part at the other side relative to the inner ring of the second ball bearing at the shaft and sticking outward in the radial direction from the shaft; and
a second spring disposed between the second flange part and the inner ring of the second ball bearing.

7. The blower according to claim 6, wherein
the impeller forms a part of a rotor rotating with respect to the sleeve along with rotation of the shaft, and
a change amount of a load by the first spring and the second spring when a deflection amount of the first spring and the second spring changes by an axial gap of the first ball bearing and/or the second ball bearing is larger than a weight of the inner ring of the second ball bearing.

8. The blower according to claim 1 further comprising:
a second flange part supported by a part at the other side relative to the inner ring of the second ball bearing at the shaft and sticking outward in the radial direction from the shaft,
wherein the sleeve includes a step part protruding inward in the radial direction at a part between the outer ring of the first ball bearing and the outer ring of the second ball bearing in the axial direction,
a third spring is disposed between the step part and the outer ring of the second ball bearing, between the step part and the outer ring of the second ball bearing in the axial direction, and
the second flange part pushes the inner ring of the second ball bearing from the other side toward the one side when the impeller rotates.

9. The blower according to claim 2, wherein
the impeller forms a part of a rotor rotating with respect to the sleeve along with rotation of the shaft, and
a maximum value of a load by the first spring is smaller than a load by the rotor.

10. The blower according to claim 2, wherein
the outer ring of the second ball bearing is restricted in movement in the axial direction.

11. The blower according to claim 2 further comprising:
a second flange part supported by a part at the other side relative to the inner ring of the second ball bearing at the shaft and sticking outward in the radial direction from the shaft,
wherein the sleeve includes a step part protruding inward in the radial direction at a part between the outer ring of the first ball bearing and the outer ring of the second ball bearing in the axial direction,
a third spring is disposed between the step part and the outer ring of the second ball bearing, between the step part and the outer ring of the second ball bearing in the axial direction, and
the second flange part pushes the inner ring of the second ball bearing from the other side toward the one side when the impeller rotates.
